(19) United States
(12) Patent Application Publication
(10) Pub. No.: US 2025/0131899 A1
(43) Pub. Date: Apr. 24, 2025

(54) MODULAR GUITAR

(71) Applicant: Troy Gregory Sonnleitner, Sun Prairie, WI (US)

(72) Inventor: Troy Gregory Sonnleitner, Sun Prairie, WI (US)

(21) Appl. No.: 18/905,021

(22) Filed: Oct. 2, 2024

Related U.S. Application Data
(60) Provisional application No. 63/541,993, filed on Oct. 2, 2023.

(51) Int. Cl. G10D 3/095; G10D 1/08; G10D 3/04; G10D 3/22

(52) U.S. Cl. CPC G10D 3/095; G10D 1/085; G10D 3/04; G10D 3/22

(57) ABSTRACT

A modular guitar is disclosed. The modular guitar includes a body comprising a carbon fiber face plate and a neck removably secured to the body by one or more quarter turn fasteners. In an alternative embodiment, the modular guitar comprises a body having a removable and replaceable face plate carrying one or more guitar electronics and a bridge, and a neck removable and replaceable on the body. In another embodiment, a modular guitar is closed comprising a body having a face place carrying one or more guitar electronics and a bridge and a heel. A neck is coupled to the body, and one or more of the body, face plate, heel, and neck are separable and interchangeable with respective alternative body, front plate, heel, and/or neck components.

### CROSS-REFERENCE TO RELATED APPLICATIONS

This application claims priority to U.S. Provisional Patent Application, Ser. No. 63/541,993, filed Oct. 2, 2024, the entire content of which is hereby incorporated by reference in its entirety.

### FIELD

The present inventions relate to the field of guitars.

### BACKGROUND

The electric guitar industry has been a mature market for some time, prominent brand names hold the highest sales but neglect the opportunity of custom orders. Many of these brands do offer such but at such a price that common customers cannot afford. High-priced custom guitars are sold by the largest names or custom specific manufactures that appeal to the experienced player. To some degree, these companies do not have the means to make these guitars less expensive as their products are made by hand and only made less expensive by outsourcing production to other countries. Currently, low cost guitars are available in the form of generic electric guitars seen in music stores or online by much of the guitar market, but typically no customization is available.

Accordingly, a need exists for a custom guitar which is easy to manufacture and provides the player with a quality, custom instrument at a reasonable price tag.

### SUMMARY

Accordingly, a modular guitar is provided. The modular guitar comprise interchangeable components, such as guitar necks and electronic components, to provide the user the ability to obtain a custom guitar at a reasonable price.

A modular guitar is disclosed. The modular guitar includes a body comprising a carbon fiber face plate and a neck removably secured to the body by one or more quarter turn fasteners.

In an alternative embodiment, the modular guitar comprises a body having a removable and replaceable face plate carrying one or more guitar electronics and a bridge, and a neck removable and replaceable on the body.

In another embodiment, a modular guitar is closed comprising a body having a face plate carrying one or more guitar electronics and a bridge and a heel. A neck is coupled to the body, and one or more of body, face plate, heel, and neck are separable and interchangeable with respective body, front plate, heel, and/or neck components.

These and other features and advantages of devices, systems, and methods are described in, or are apparent from, the following detailed descriptions and drawings of various examples of embodiments.

### BRIEF DESCRIPTION OF DRAWINGS

Various examples of embodiments of the systems, devices, and methods will be described in detail, with reference to the following figures, wherein:

FIG. 1 is an isometric view a modular guitar according to one or more examples of embodiments;

FIG. 2 is view of the modular guitar of FIG. 1, showing a view from the opposing side of the guitar;

FIG. 3 is an exploded view of the modular guitar shown in FIG. 1;

FIG. 4 is an isometric view of one or more examples of a guitar body for use with the modular guitar shown in FIG. 1;

FIG. 5 is an isometric view of a face plate for use with the guitar body shown in FIG. 4;

FIG. 6 is an isometric view of a base or core for use with the guitar body shown in FIG. 4;

FIG. 7 is an isometric view of the base or core shown in FIG. 6, taken from the opposing side of the base or core;

FIG. 8 is an exploded view of the base or core, showing a body composed of a core with front and rear trim pieces, absent the face plate;

FIG. 9 is an isometric view of a neck assembly for use with the modular guitar shown in FIG. 1 according to one or more examples of embodiments;

FIG. 10 is an exploded view of the neck assembly shown in FIG. 9; and

FIG. 11 is a second isometric view of the neck assembly shown in FIG. 9, taken from the opposing side of the assembly.

It should be understood that the drawings are not necessarily to scale. In certain instances, details that are not necessary to the understanding of the invention or render other details difficult to perceive may have been omitted. For ease of understanding and simplicity, common numbering of elements within the numerous illustrations is utilized when the element is the same in different Figures. It should be understood, of course, that the invention is not necessarily limited to the particular embodiments illustrated herein.

### DETAILED DESCRIPTION

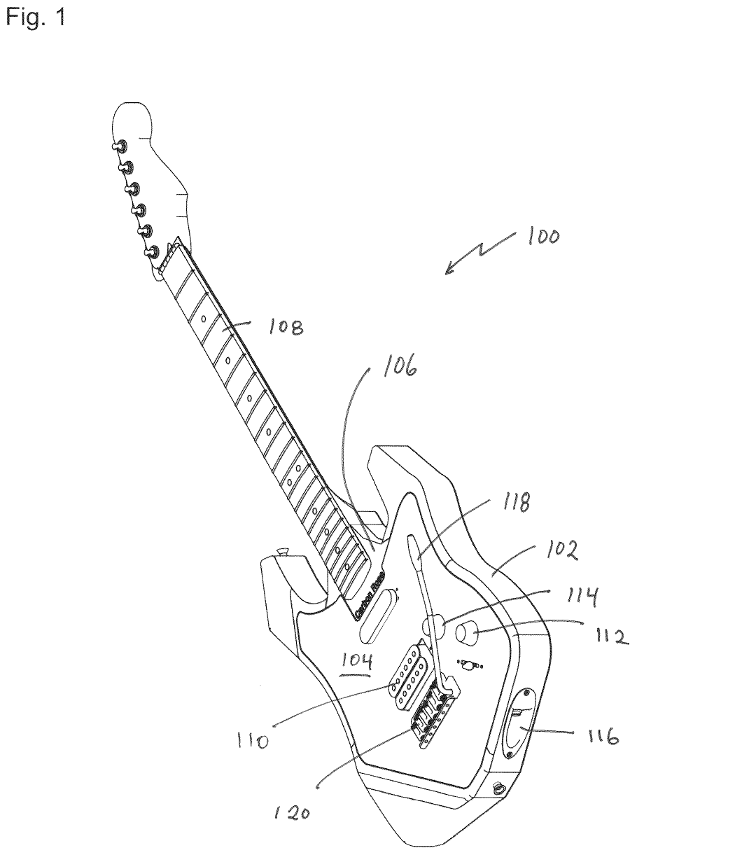

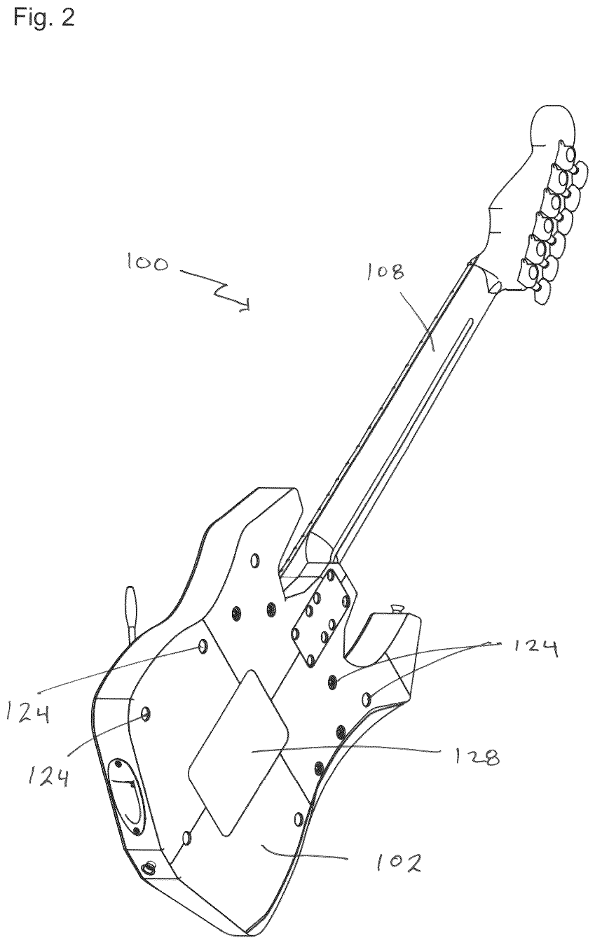

Referring to the Figures, a modular guitar 100 is disclosed. In FIGS. 1-3, a modular guitar 100 comprising separable components, including but not limited to, a body 102, a front or face plate 104, a heel 106, and a neck 108 is shown. Additional standard guitar components, such as various electronics (i.e., pickups 110, volume control 112, tone control 114, input jack 116 and associated circuitry), guitar strings (not shown) and associated attachment devices such as a tremolo assembly 118, bridge 120, and so forth, may also be removably attached or easily replaceable on the guitar 100. In some examples of embodiments, the jack plate may be mounted at vertical angle for security when using a strap.

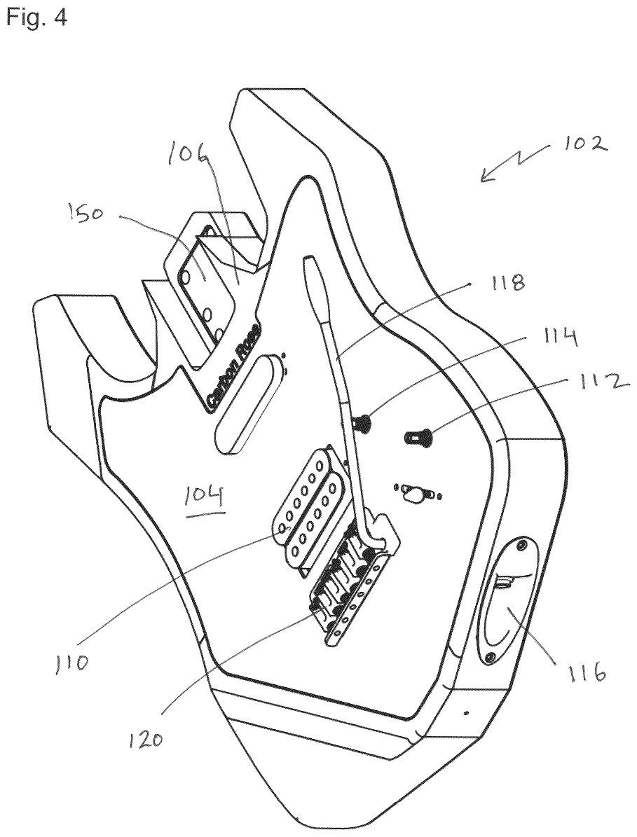

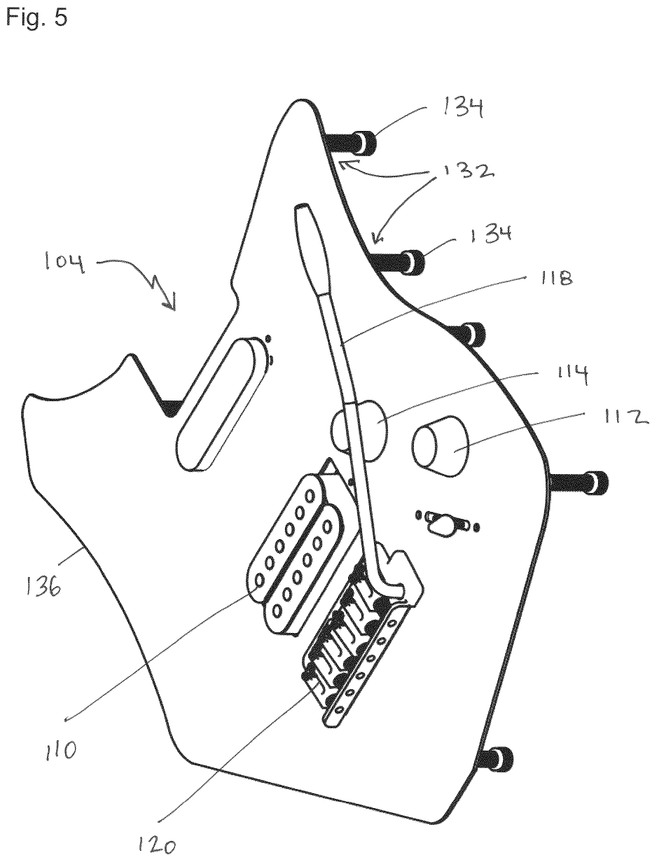

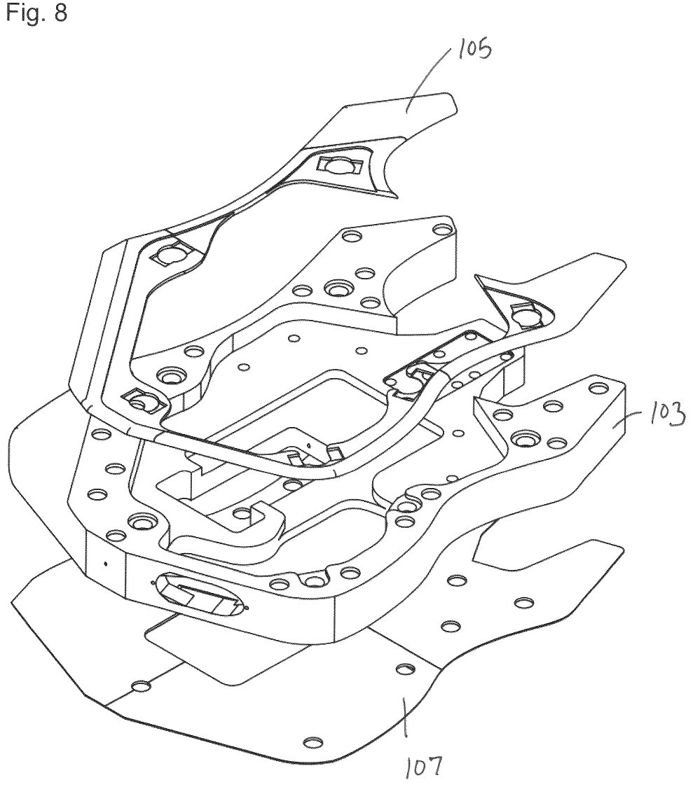

Referring to FIGS. 4-8, the body 102 may be a single component or formed of multiple separable components. For example, the body 102 may comprise a base 103 and a face plate 104, as well as one or more of the electronics described above. In another example, the body 102 may comprise a base 103, a heel 106, and a face plate 104, as well as one or more of the electronics described above. In a further example, the body 102 may be composed of a core or base 103 and one or more trim pieces, such as a front trim 105 and a back trim 107 as shown in FIG. 8. Acting as a ballast, the body 102 or body core may be shaped to hold the electronics, hardware, and to redistribute the weight of the guitar 100 down a single axis.

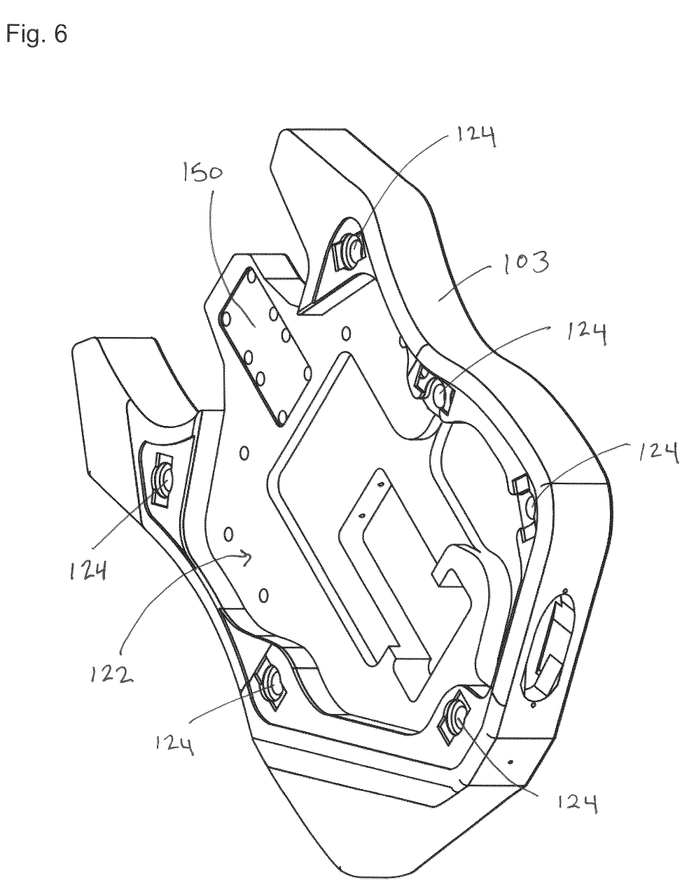

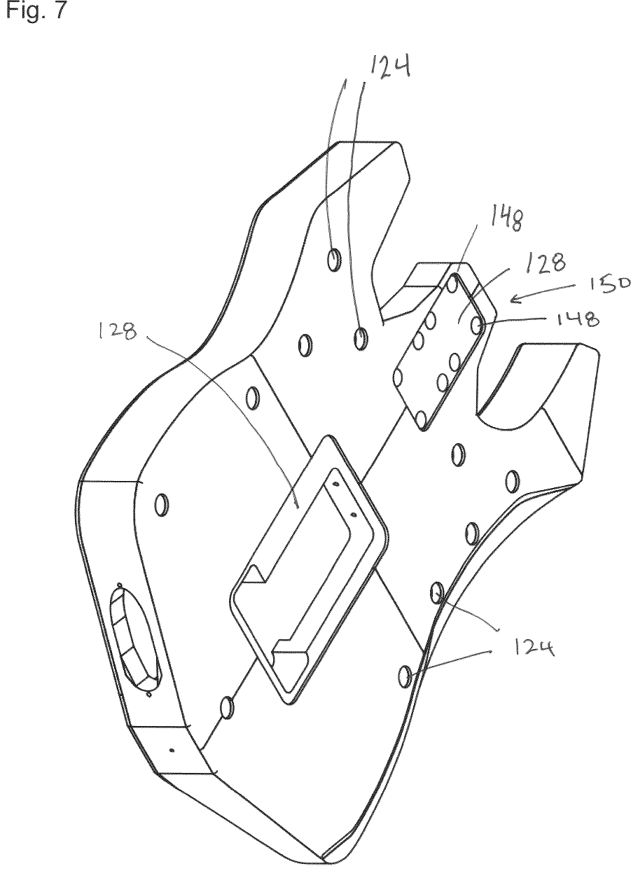

In the examples shown, the guitar body 102 has a routed or recessed geometry or area 122 shaped for or to receive numerous setups and configurations, such as but not limited to the attachment of different electronics, different face plates 104, and different necks 108. The body 102 further comprises a plurality of attachment points 124, which in the illustrated embodiment comprise through bores or holes for receipt of one or more fasteners 126 comprising holes sized for various fasteners. As can be seen in FIGS. 6-7, the attachment points 124 may be accessible from rear of guitar body 102. The body 102 may also have one or more recesses 128 for a plate with serial identification and logo and/or for a plate to cover the tremolo assembly. The guitar body 102 may be composed of any suitable, durable material. Examples include, but are not limited to wood (e.g., alder or hemp wood), 3D printed, recycled material, renewable materials. While a specific body 102 shape is shown, it is understood that various shapes, geometries, and configurations may be substituted in place of the illustrated design without departing from the overall scope of the disclosed modular guitar 100.

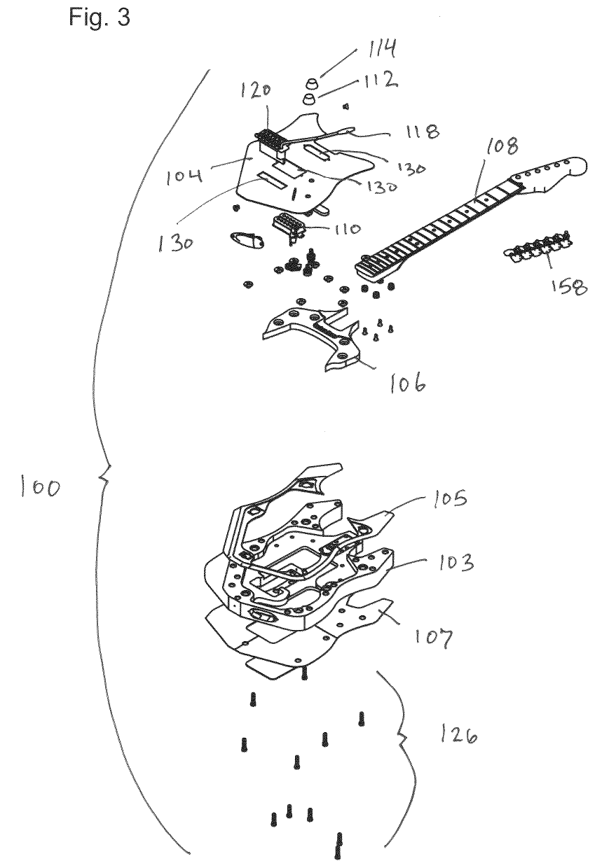

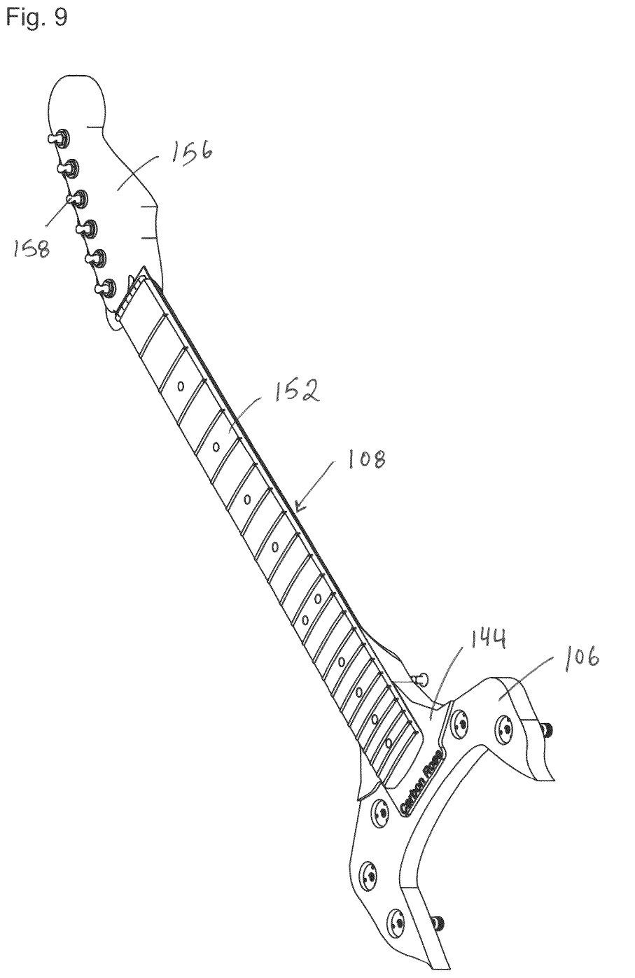

Referring to FIGS. 3-5, the front or face plate 104 is illustrated. The face plate 104 may be composed of a generally flat plate having one or more apertures 130 sized to receive one or more guitar electronics. In one or more preferred examples of embodiments, the face plate 104 may be composed of carbon or a carbon fiber. According to the examples shown in the illustrated embodiments, mounting may be done on the underside of the plate 104. As shown in FIG. 9, the back of the plate 104 may comprise one or more receptors 132 for fasteners 134. While a specific configuration and number of apertures are illustrated, variation thereon which are suitable for different electronic components and configurations may be used without departing from the overall scope of the disclosed modular guitar 100. The electronics may be attached to the back or underside of the plate 104 (except the input jack), as well as other necessary hardware. In one or more examples of embodiments, the plate 104 matches the bridge 120 being used, but other electronics can be interchanged with other like devices. The bridge 120 can also be exchanged with a similarly dimensioned device. In a further embodiment, one bridge 120 setup may have various pickup 110 configurations (HS, HSH, HSS, SSS, etc.). In one or more examples of embodiments, the outer edge 136 geometry of the face plate 104 does not change from plate to plate and the bridge 120 is positioned to match the scale length of the neck 108 being used to account for alternative guitar styles, such as but not limited to a bass or a 7-string. While a specific face plate 104 shape is shown, it is understood that various shapes, geometries, and configurations may be substituted in place of the illustrated design without departing from the overall scope of the disclosed modular guitar 100.

Referring to FIGS. 3-4, the heel 106 mates flush with the guitar body 102, and in one or more examples of embodiments will generally retain the same geometry, except around the neck 108 which is separable and interchangeable with different shaped/sized necks 108. The heel 106 is composed of a body attachment portion 138 having one or more through bores or apertures 140 for receipt of fasteners 142; and a neck attachment portion 144 comprised of a receiving slot 146 configured to align the neck fasteners holes 148 with the corresponding neck fastening location 150 on the body 102 and stabilize the lateral movement of the neck 108 when secured to the body 102. In one or more example of embodiments, the heel 106 does not determine which plate 104 needs to be used but does determine which bridge 120 to use, i.e., the heel 106 matches the geometry for the neck 108 being used, which determines the scale length so the user can use on heel 106 for several pickup 110 configurations. The heel 106 can be made from a variety of materials, including but not limited to: wood (such as hemp wood), wood or hemp wood w/carbon fiber reinforcement, 3D printed, or any material also used to make the guitar body 102. While a specific heel 106 shape is shown, it is understood that various shapes, geometries, and configurations may be substituted in place of the illustrated design without departing from the overall scope of the disclosed modular guitar 100.

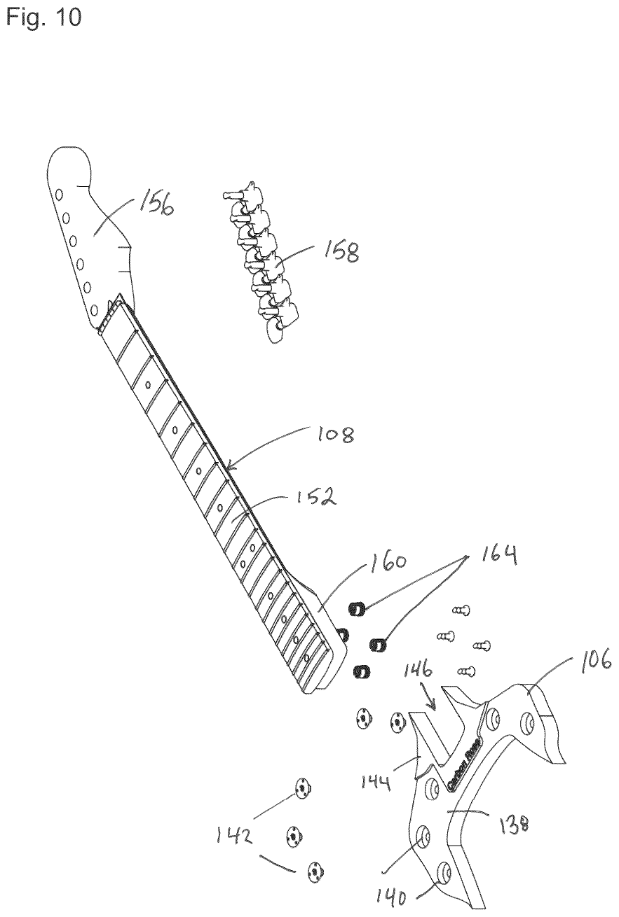

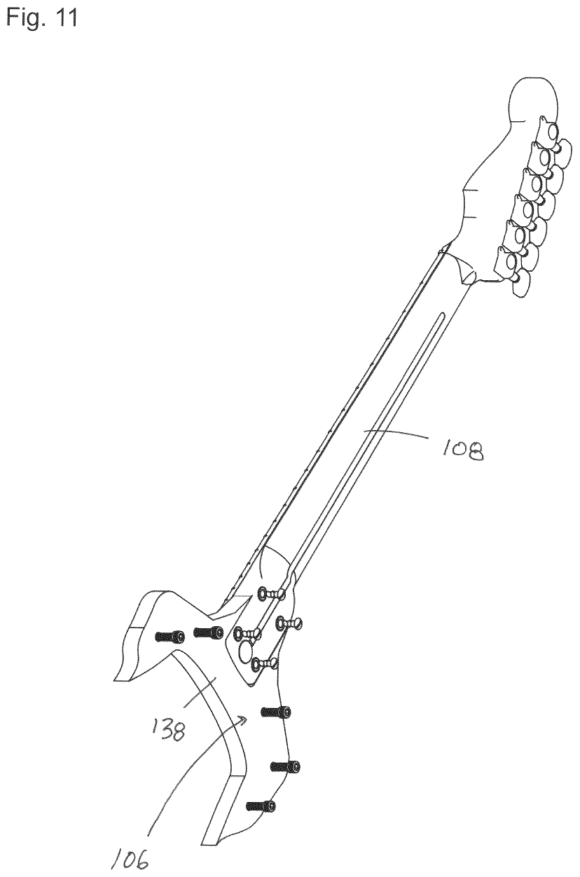

Any suitable neck 108 may be used with the modular guitar 100, one example of which is shown in FIGS. 9-11. The neck 108 can be standard, bass, 7 string, 5 string bass, 8 string, different scale lengths. The neck 108 comprises a playable area 152, such as a series of frets 154, a tuning section 156 which received a tuning peg assembly 158, and an attachment section 160 which in one or more examples of embodiments is composed of a plurality of through bores or apertures 164 which receive fasteners 166. The fastener mounting is dimensioned to align with the guitar body mount apertures. While a specific neck 108 shape is shown, it is understood that various shapes, geometries, and configurations may be substituted in place of the illustrated design without departing from the overall scope of the disclosed modular guitar 100.

The various components of the modular guitar 100 described herein may be releasably connected by one or more fasteners. In one or more examples of embodiments, all front or face plate 104 mounting points 132 are used, all heel 106 mounting points 140 are used, and all neck mounting points 148 are used; although variations are contemplated in which less than all the mounting points are used due to variation in shape or design of one of the components. Likewise, while specific fastener locations and numbers are shown in the drawings, it is understood that a variety of configuration that accomplish the secure attachment of the various components may be substituted in place of the currently illustrated designs. Suitable fasteners for use in assembling the modular guitar 100 include, but are not limited to generic bolts, hex bolts, quarter turn fasteners, and other quick release fasteners. Fastener mounting can be via a variety of mechanisms: example of which include: pressed in, glued/epoxied in, VHB tape, inlaid in print, and the like. In one or more preferred examples of embodiments, racing (quarter turn) fasteners are used for securing the neck 108 to the body 102 and allow for a quick swap of the neck 108 for teardown, travel, and shimming. A quarter turn fastener may comprise a housing that it will lock into under compression. The compression comes when you turn it, once turned, the rubber may will push the fastener out, locking it in place. Alternatively, a spring may be used to provide compression.

Advantageously, by using the same body design a myriad of fiber types can be used. In or more more examples of embodiments, two molds may be used to create four pieces to be attached to a central body. Moreover, the modular guitar 100 is easy to manufacture. Using only basic CNC tool paths, the guitar's body 102, heel 106, and face plate 1094 can be cut and assembled. Moreover, the modular aspect of the guitar 100 allows the player to change from a standard six string, to bass, or other electric guitar type. The modular guitar 100 design also provides the player with a quality, custom instrument at a reasonable price tag. If carbon fiber is used, the strength and weight advantages of carbon fiber allow the instrument to reevaluate the concept of ergonomics while bringing a new and adaptable appearance for the consumer. A unique sound will also be produced as compared to wooden counterparts.

As utilized herein, the terms “approximately,” “about,” “substantially”, and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the invention as recited in the appended claims.

It should be noted that references to relative positions (e.g., “top” and “bottom”) in this description are merely used to identify various elements as are oriented in the Figures. It should be recognized that the orientation of particular components may vary greatly depending on the application in which they are used.

For the purpose of this disclosure, the term “coupled” means the joining of two members directly or indirectly to one another. Such joining may be stationary in nature or moveable in nature. Such joining may be achieved with the two members or the two members and any additional members being integrally formed as a single unitary body with one another or with the two members or the two members and any additional intermediate members being attached to one another. Such joining may be permanent in nature or may be removable or releasable in nature.

It is also important to note that the construction and arrangement of the system, methods, and devices as shown in the various examples of embodiments is illustrative only. Although only a few embodiments have been described in detail in this disclosure, those skilled in the art who review this disclosure will readily appreciate that many modification are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements show as multiple parts may be integrally formed, the operation of the interfaces may be reversed or otherwise varied, the length or width of the structures and/or members or connector or other elements of the system may be varied, the nature or number of adjustment positions provided between the elements may be varied (e.g. by variations in the number of engagement slots or size of the engagement slots or type of engagement). The order or sequence of any process or method steps may be varied or re-sequenced according to alternative embodiments. Other substitutions, modifications, changes and omissions may be made in the design, operating conditions and arrangement of the various examples of embodiments without departing from spirit or scope of the present inventions.

While this invention has been described in conjunction with the examples of embodiments outlined above, various alternatives, modifications, variations, improvements and/or substantial equivalents, whether known or that are or may be presently foreseen, may become apparent to those having at least ordinary skill in the art. Accordingly, the examples of embodiments of the invention, as set forth above, are intended to be illustrative, not limiting. Various changes may be made without departing from the spirit or scope of the invention. Therefore, the invention is intended to embrace all known or earlier developed alternatives, modifications, variations, improvements and/or substantial equivalents.

The technical effects and technical problems in the specification are exemplary and are not limiting. It should be noted that the embodiments described in the specification may have other technical effects and can solve other technical problems.

1. A modular guitar comprising:
a body comprising:
a face plate carrying one or more guitar electronics and a bridge;
a heel; and
a neck coupled to the body;
wherein one or more of the body, face plate, heel, and neck are separable and interchangeable with respective alternative body, front plate, heel, and/or neck components.

2. The modular guitar of claim 1, wherein one or more of the body, the face plate, the heel, and the neck are secured by quick release fasteners.

3. The modular guitar of claim 1, wherein the body, the face plate, the heel, the neck comprise a plurality of aligned though bores for receipt of one or more fasteners.

4. The modular guitar of claim 1, wherein one or more of the body, the face plate, the heel, and the neck are composed of carbon fiber.

5. The modular guitar of claim 1, wherein the neck is aligned on the body by the heel which comprises a receiving slot for the neck.

6. A modular guitar comprising:
a body having a removable and replaceable face plate carrying one or more guitar electronics and a bridge; and
a neck removable and replaceable on the body.

7. The modular guitar of claim 5, wherein the face plate is carbon fiber.

8. The modular guitar of claim 5, wherein quarter turn fasteners removably secure the neck to the body.

9. The modular guitar of claim 6, wherein the neck is aligned on the body by a heel having a receiving slot for the neck.

10. A modular guitar comprising:
a body comprising a carbon fiber face plate; and
a neck removably secured to the body by one or more quarter turn fasteners.

11. The modular guitar of claim 10, wherein the neck is aligned on the body by a heel having a receiving slot for the neck.

12. The modular guitar of claim 10, wherein the carbon fiber face plate carries one or more guitar electronics and a bridge.
